(19) United States
(12) Patent Application Publication
(10) Pub. No.: US 2010/0182164 A1
(43) Pub. Date: Jul. 22, 2010

(54) ELECTRONIC TRAFFIC SIGNAGE

(76) Inventor: Keyvan T. Diba, Los Angeles, CA (US)

Correspondence Address: LAUSON & TARVER LLP, 880 APOLLO STREET, SUITE 301, EL SEGUNDO, CA, 90245, US

(21) Appl. No.: 12/690,868

(22) Filed: Jan. 20, 2010

Related U.S. Application Data
(60) Provisional application No. 61/146,192, filed on Jan. 21, 2009.

(51) Int. Cl. G08G 1/095

(52) U.S. Cl. 340/907

(57) ABSTRACT

An illuminated display apparatus for supplementing street signals includes a housing containing an LED array capable of producing multicolored and animated images, a bracket system holding the housings together wherein a row of multiple housings and LED arrays may be assembled together to create larger displays, and wherein a system of brackets supports the housings at an angle from vertical for viewing by passing vehicles below. The display may also include a solar array, loudspeakers, strobe apparatus and automatic brightness dimming.

This application claims the benefit of the filing date of provisional application No. 61/146,192.

### BACKGROUND

The present invention is directed to electronic signals including compact hanging signage presenting highly visible visual warnings, messages or information to drivers during the regular course of driving, and in emergency or other situations.

Electrically powered traffic signals or “stop lights” have been around since the early twentieth century. These signals have remained essentially the same in general concept with a few refinements added such as turn arrows and “walk” or “don't walk” messages. Over the years, ground travel in and around cities has become increasingly constrained with growing vehicular traffic including passenger cars, trucks, emergency vehicles, busses, trains and the like all moving in densely-populated areas.

While non-passenger vehicles such as police cars, fire trucks and ambulances typically have visual and audible warnings of their approach into intersections, they frequently don't have the right-of-way and their warnings, often unseen and/or unheard, lead to serious collisions. In view of the increased density and speed of vehicular traffic, and the current state of signage technology, it is desirable for municipalities to provide significantly improved signaling and signage at intersections for better vehicular flow, safety, and to provide warnings and information among other reasons.

A variety of devices proposed, including earlier patents and applications by the present inventor, presented ambiguous and potentially confusing information to drivers. Often complex and of expensive construction, these devices have not been widely installed. Since known systems have been inefficient and ineffective when providing information to drivers for collision avoidance or other purposes, the present invention as described herein takes major steps forward towards accomplishing these objectives. One important goal of the present invention is to provide a more effective traffic signal preemption system. Currently in the market, devices exist that can preempt the normal operation of a traffic signal, such as a strobe light system. While this is useful to emergency vehicles, drivers are often unaware of where the emergency vehicles are as they approach an intersection. By providing programmed LED graphical movement as herein shown and described, the present invention aims to solve problems in the prior art.

### SUMMARY

In order to solve the aforementioned problems in the prior art, a modular, LED-based traffic sign is proposed. When assembled, the sign frequently comprises a series of individual modular panels. An individual panel is preferably made of a clear front case, an LED panel, a water proof gasket, and a rear case. The gasket prevents moisture from intrusion into the panel. Additionally, a panel may be powered by an optional auxiliary power source located in a separate box attached to a traffic pole. A loudspeaker may be incorporated into the box.

Preferably, individual panels rectangular and approximately 18 inches by 24 inches in size. Since the panels can be arranged along either the 18 or 24 inch side, signs of different sizes can be produced. In particular, two or more panels may be connected along their 24 inch sides for code compliant traffic regulatory signs. For street signage, two or more panels may be connected along their 18 inch sides.

To anchor panels in position and provide a slight downward tilt to the device when installed, a series of brackets are affixed to the top and bottom of the installed panel. The brackets have an elongated piece and a shortened piece affixed together, and connected to the panel with screws. To avoid interfering with the LED display, the brackets may be clear. The combination of the elongated and shortened bracket pieces causes the panel to hang off-center and suspend at an angle from its support. This downward tilt, preferably around five degrees, affords better driver visibility.

Typically, brackets are used for both upper and lower portions of the panel. Attached to the upper portion, the panel hangs from the bracket and tilts toward drivers. Attached to the lower portion, the bracket increases the panel tilt and serves as a guard or bumper to protect the panel face. The brackets attach to either the 18 inch or 24 inch side of a panel to make larger or smaller signs according to governmental sign specifications.

A series of panels may be assembled in a row, creating a larger sign. To preserve the alignment of the panels, the brackets may be incorporated into a rail system. To properly balance and level the panels, the rail system includes adjustable assemblies that attach to light posts or other signal supports. The edges of individual panels are beveled to diffuse light and minimize the appearance of seams between the panels when multiple panels are connected. Preferably, the bevel angles are approximately 45 degrees from the panel face.

One alternative embodiment of the device is designed to function as a single panel mini-alert signal. The mini-alert signal is preferably contained in a generally oval shaped housing with a visor or shroud. A front panel having a multiplicity of high-output light emitting diodes (LEDs) or the equivalent, provide highly-visible animation. Alternatively the device may be in the form of a rectangle with rounded-off corners (not shown) to more easily, optionally display street names as described below. A pair of loudspeakers project downward and act as sirens if necessary. The loudspeakers are preferably located on the bottom of the housing to keep water and dust out of the signal. The signal is generally sealed to provide weather resistance. The LED screen and speakers may be in direct or wireless communication with stop lights, emergency vehicles and municipal vehicles among others to receive instructions and display warnings or information.

The mini-alert unit's back panel preferably includes photovoltaic (or equivalent) solar panels to provide a primary (or alternate) power source, which may also include an auxiliary re-chargeable battery (not shown) inside. On the back panel an adjustable bracket with a pair of connectors is used for associating the unit with conventional traffic signal poles of varying diameters. The adjustable bracket preferably includes a crossbar separating the connectors, which conveniently serves as a handle for carrying the unit.

Preferably, the top of the unit has a photo sensor to measure the ambient light level and adjust the brightness of the LED screen as appropriate. A strobe light draws attention to the unit when emergency messages are displayed. The unit is of a modular design such that portions may be easily removed and replaced without extensive disassembly. For example, one size of visor may be easily removed and another size visor connected to the unit.

Both the panel embodiment and the mini-alert signal unit may be used to alert traffic to emergency vehicles approaching an intersection. For traffic moving in front of or behind an emergency vehicle, the device can signal drivers to move to the right or pull over in a manner such that an emergency vehicle may pass. Preferably, the LED panels can show a chevron-shaped arrow or series of arrows directing drivers to pull over. Optionally, a red “STOP” display may also be shown. In other embodiments, animated depictions of emergency vehicles may alert drivers. It is anticipated by way of analogy that the aforementioned functions can apply to busses, bus lanes, trains and train tracks as well. In each of these instances, the signage can alert vehicles to the presence of collision hazards.

The device may be used to alert drivers to other information as well. In one embodiment, it may signal fire hazards or other localized emergencies and directions away from the area. For example, a directional indicator, e.g. N (for North) may direct drivers to proceed in that direction. If there is an AMBER alert (i.e. The U.S. Dept. of Justice—America's Missing Broadcast Emergency Response), then the device may display a vehicle license number in designated areas. At nighttime, when unlit street signs are difficult to see, cross street names may be displayed at major intersections. The street name display can be in the contrasting colors of street signs according to a particular municipality. Preferably, since the mini-alert system unit comprises on board solar power, it may function as the primary traffic signal in the event of a power interruption to the conventional stop light.

### BRIEF DESCRIPTION OF THE FIGURES

FIG. 1 shows a perspective exploded view of a single panel version of the device with an optional remote power source.

FIG. 2 shows a perspective, front and profile view of a multi-panel version of the device when used to display traffic regulatory signage.

FIG. 3 shows a front and perspective views of a multi-panel version of the device when used to display street signs.

FIG. 4 shows a perspective front view, back view and exploded view of a single panel version of the device.

FIG. 5 shows the device in action when stopping cross traffic for an emergency vehicle to pass through an intersection.

FIG. 6 shows the device in action when instructing vehicles to pull over as an emergency vehicle approaches in a parallel direction to traffic.

FIG. 7 shows the device in action when warning vehicles of a bus approaching an intersection.

FIG. 8 shows the device in action when warning vehicles of a train approaching an intersection.

FIG. 9 shows the device in action when providing directions away from an emergency, displaying an AMBER alert, and displaying a street sign.

FIG. 10 shows the device in action when serving as a stop light in the event of a power outage.

### DESCRIPTION

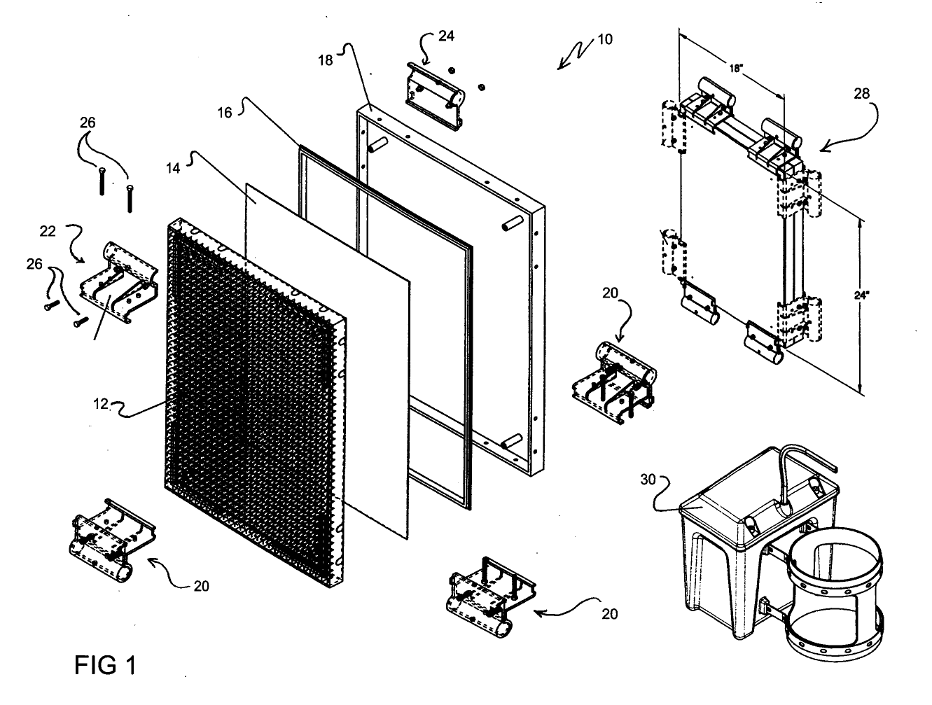

Referring to FIG. 1, an exploded view of an individual panel is shown and described. A preferred embodiment of the traffic alert signal comprises a series of individual modular panels 10. Each panel 10 comprises a clear front case 12, an LED panel 14, a water proof gasket 16, and a rear case 18. The gasket 16 prevents moisture intrusion into the panel 10.

To hold an individual panel 10 together and provide a slight tilt to the panel 10 when installed, a series of brackets 20 are affixed to the panel 10. The brackets comprise an elongated piece 22 and a shortened piece 24, and are preferably affixed together and to the panel 10 with screws 26. In another preferred embodiment, the brackets 20 are clear. The combination of the elongated 22 and shortened 24 pieces of the bracket cause the panel 10 to hang off-center at an angle when suspended from a support. The downward tilt provides better visibility. Preferably, the angle is around five degrees.

Preferably, the brackets 20 can be used at the top and bottom of a suspended panel 10. When attached at the top, the off-center nature of the bracket 20 causes the panel 10 to tilt forward for increased driver visibility. When attached to the bottom, the off-center nature of the bracket 20 causes the panel 10 to tilt further, and additionally serves as a guard or bumper, protecting the face of the panel 10.

As shown in FIG. 1, each panel comprises an 18 by 24 inch rectangle. The panel may be bracketed along any of its four edges. In this manner, 24 inch traffic regulatory signs can be created by bracketing the 18 inch edge, and 18 inch street signs can be created by bracketing the 24 inch edge. Additionally, the panel 10 may be driven by an optional auxiliary power source located preferably with a loudspeaker in a separate box 30 attached to a traffic pole.

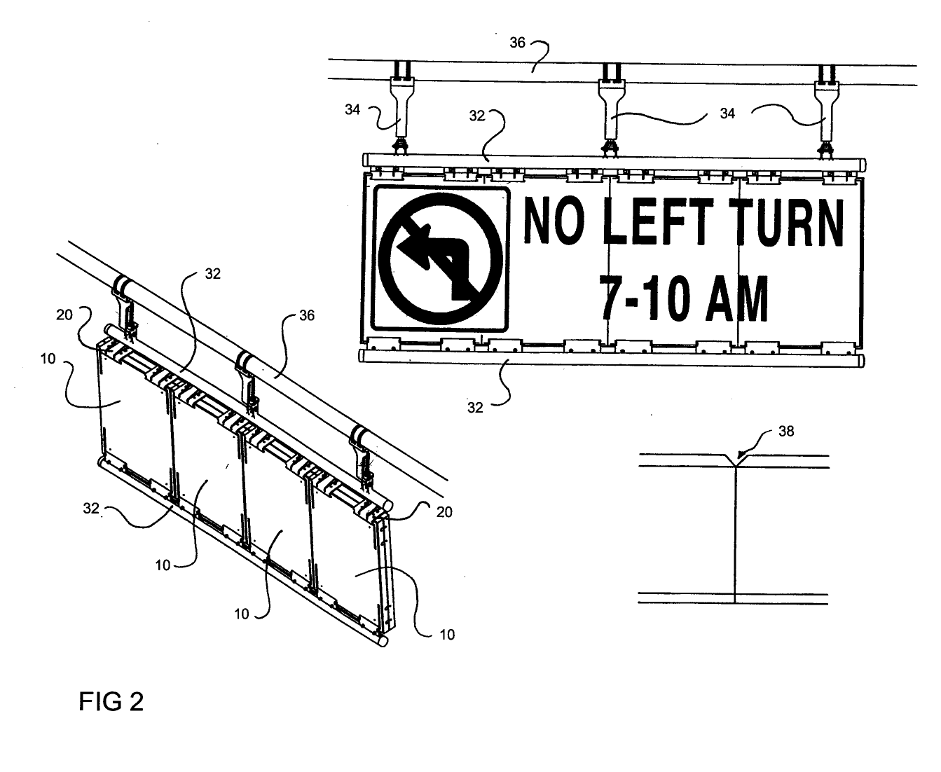

Referring now to FIG. 2, panels 10 are shown connected in a series along their 24″ sides to display traffic regulatory signage. In this embodiment, the brackets 20 are preferably inserted into hollow portions of the rails 32. In another embodiment the brackets 20 comprise the rails 32. To properly balance and level the panels 10, the rails 32 also comprise assemblies 34 that may be adjusted, and which attach to a light pole 36. Also shown in FIG. 2, the panels 10 have bevels 38. The bevels 38 diffuse light and minimize display interruption between the panels 10. Preferably, the bevels 38 are disposed at about a 45 degree angle from the direction a panel 10 faces.

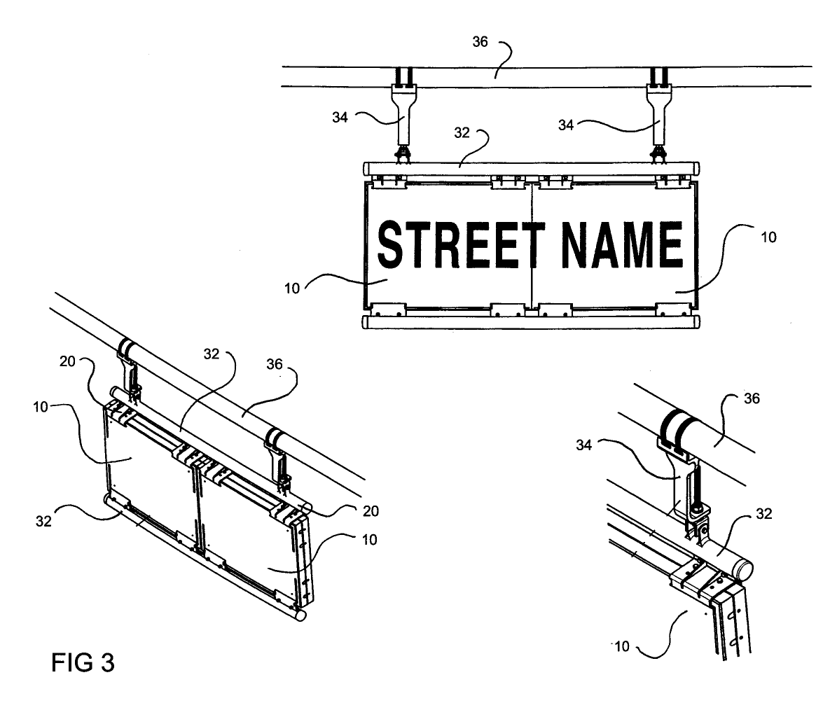

Referring to FIG. 3, the device is shown wherein each panel 10 is connected on its 18 inch side to display street signage. In this embodiment, since the panels 10 are connected along their 18 inch sides, longer words may be created with fewer panels. In both versions, the LED displays are programmable to show static street and traffic signs, and optionally an may show static or animated chevron shaped arrows and other graphics when necessary during emergencies.

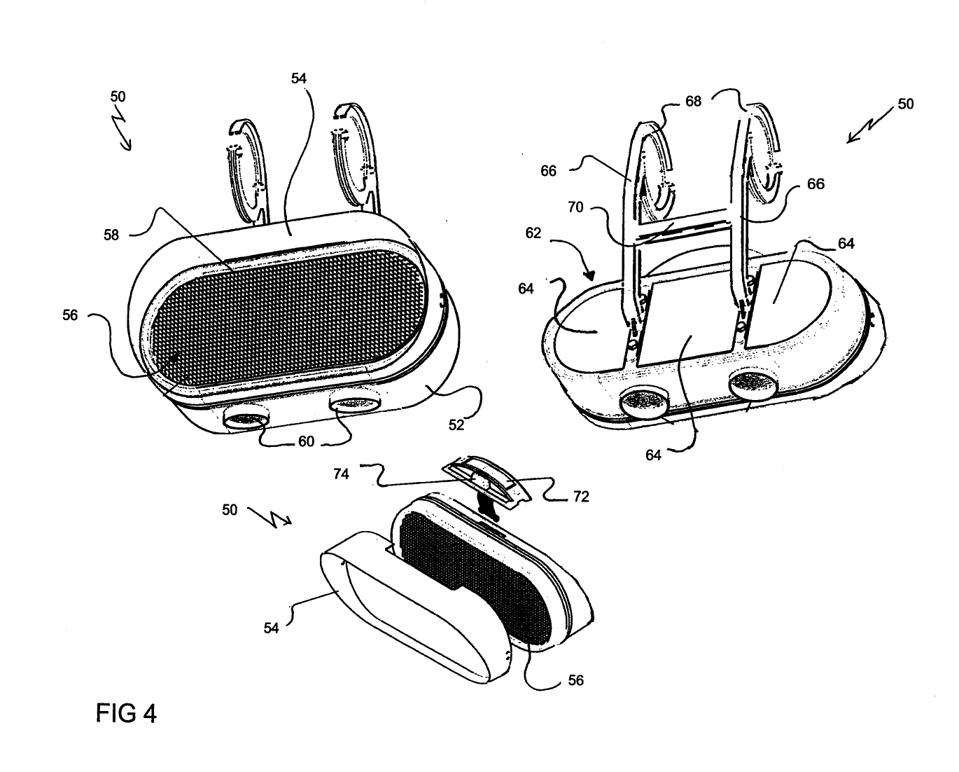

Referring to FIG. 4, a front perspective view of a single panel version of the device as a mini alert signal 50 is shown and described. The signal 50 is preferably contained in a generally oval shaped housing 52. A visor 54 or shroud is disposed on the top and around the sides of a front panel 56 having a multiplicity of high-output tri-color light emitting diodes (LEDs) 58 or an equivalent thereof, providing highly-visible animation. Alternatively the device may be an elongated rectangle with rounded-off corners (not shown) to more easily display street names as described below. A pair of loudspeakers 60 project downward and have siren capability. The loudspeakers 60 are preferably located on the bottom of the housing 52 to keep water and dust out of the unit 50. The unit 50 is generally sealed to provide weather resistance. The LED screen 56 and speakers 60 are in direct or optionally in wireless communication with stop lights, emergency vehicles and municipal vehicles among others to receive instructions and display warnings or information. The oval shape of the mini alert signal has psychological significance to drivers since it mimics the shape of a normal traffic light. For this reason, drivers may more quickly and smoothly transition from using the main light to the mini alert in an emergency or blackout.

Also shown in FIG. 4, the back panel 62 of the unit 50 preferably includes photovoltaic (or equivalent) solar panels 64 to provide a primary (or alternate) power source for the unit 50, which may also include an auxiliary re-chargeable battery (not shown) inside. On the back panel 22 there is an adjustable bracket 66 with a pair of connectors 68 for associating the unit with conventional traffic signal poles of varying diameters. The adjustable bracket 66 preferably includes a crossbar 70 separating the connectors 68, which also conveniently serves as a handle for carrying the unit 50.

Still referring to FIG. 4, an exploded view of the unit 50 is shown. Preferably, at the top of the unit 50, there is a photo sensor 72 to measure the ambient light level and adjust the brightness of the LED screen 56 as appropriate. Further preferably included is a strobe light 74 to draw attention to the unit 50 when an emergency message is displayed. The unit 50 is of a modular design such that portions of it may be easily removed and replaced without great disassembly. For example, an optional visor 76 may be removably connected to the unit 50.

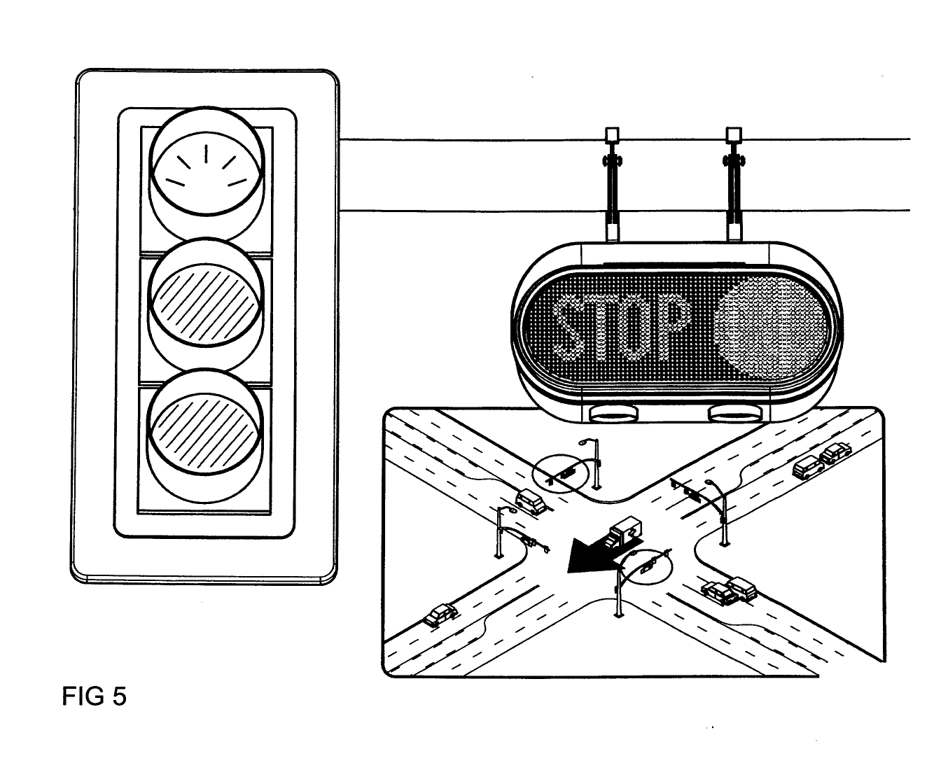

The structure of the device having been shown, operation of the device will now be described. The signal unit may be used either to stop cross traffic or cause traffic to pull to the side when emergency vehicles approach intersections. Referring to FIG. 5, a red or other color “STOP” display may alternate with an emergency vehicle graphic moving left-to-right or right-to-left as necessary, alerting drivers to the direction of emergency vehicles traveling through intersections and decreasing the likelihood of collisions.

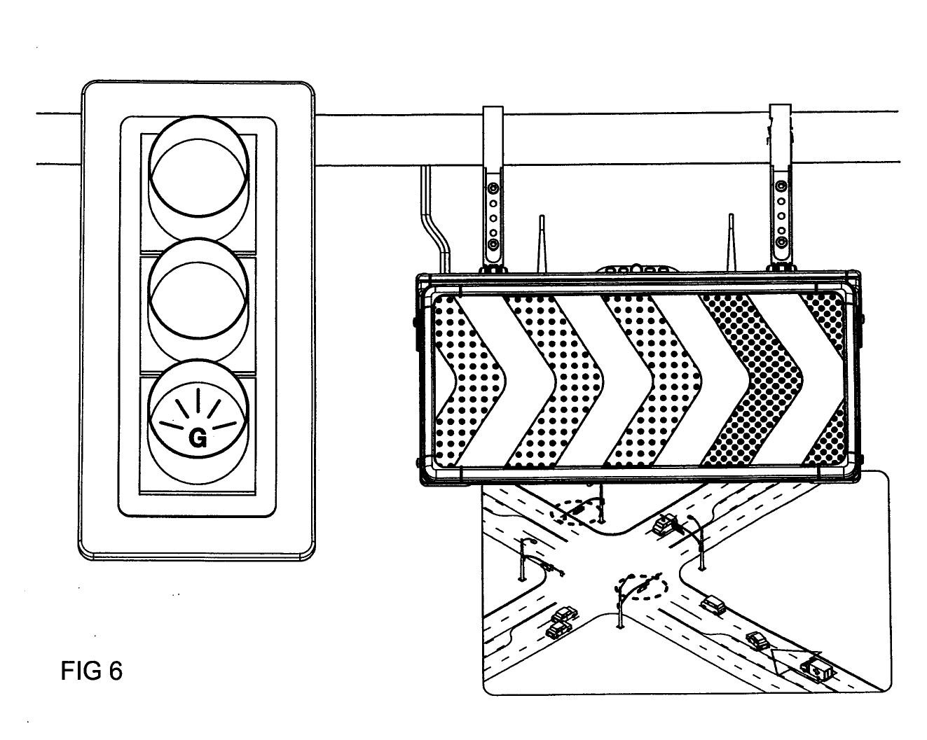

Referring to FIG. 6, for traffic moving parallel to emergency vehicles, the device can signal drivers to move to the right or pull over. By alerting drivers in advance of approaching emergency vehicles, response times will be reduced. It is anticipated by way of analogy that the aforementioned functions can apply to busses, bus lanes, trains and train tracks as well. In each of these instances, the signage can alert vehicles to the presence of collision hazards. It should be noted that either the single panel device or modular panel device may be used for this purpose.

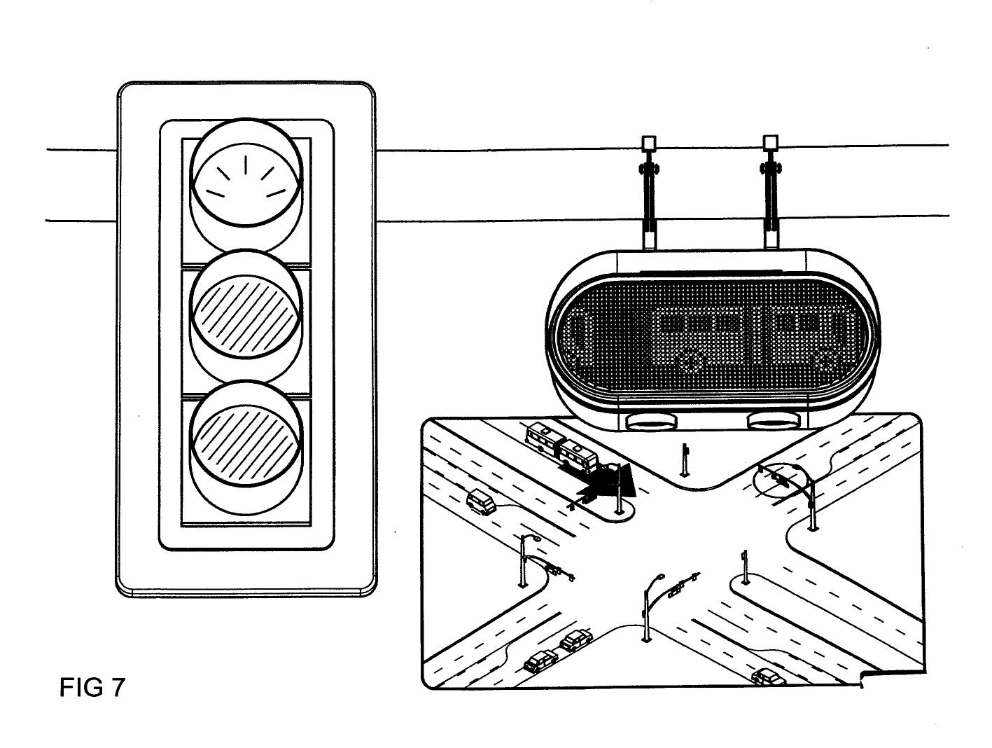

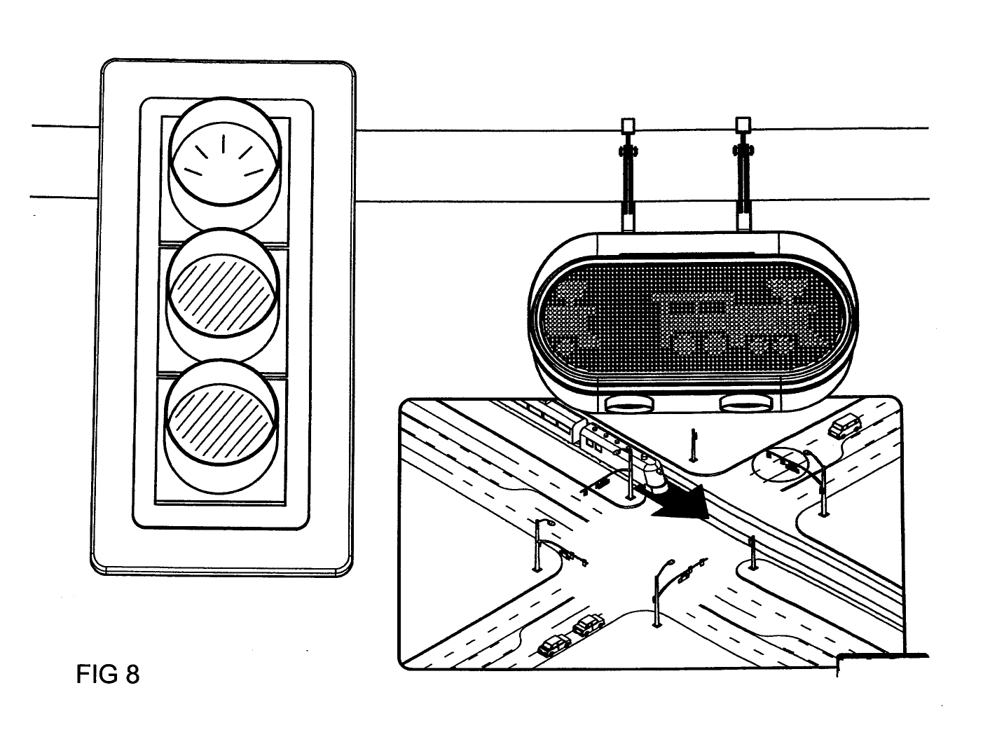

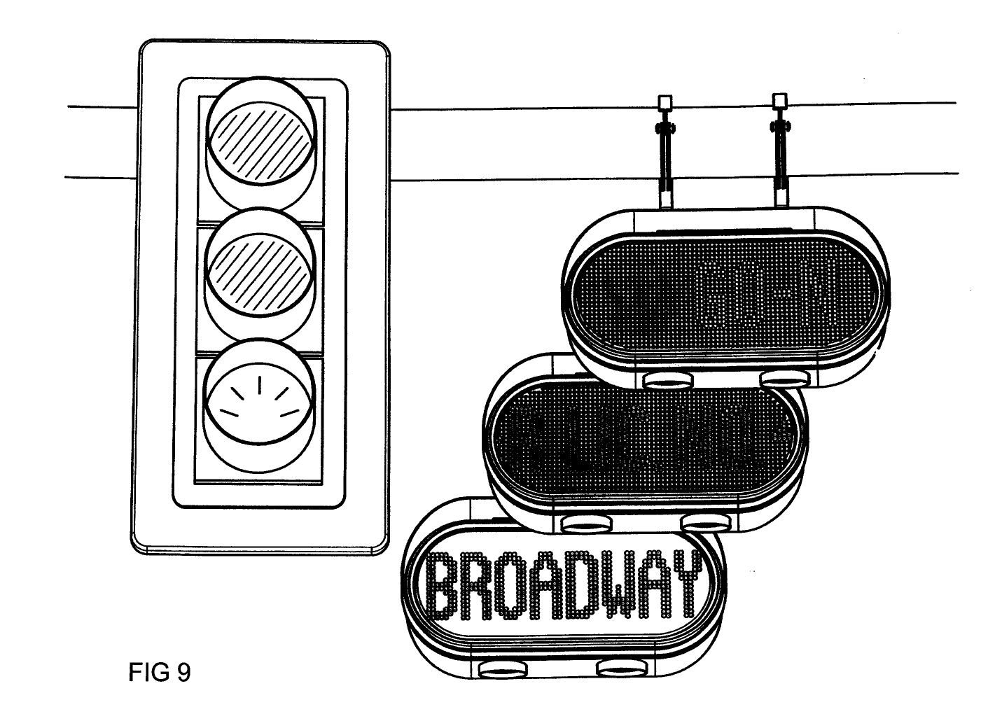

The device may also be employed to alert drivers to other information. Referring to FIG. 7, the device alerts drivers to a bus approaching an intersection. Referring to FIG. 8, the device alerts drivers to a train approaching an intersection. Referring to FIG. 9, the device is shown alerting drivers to fire hazards or other localized emergencies. In this example, a directional indicator, “N” (for North) directs drivers away from a fire. During an AMBER alert (i.e. The U.S. Dept. of Justice—America's Missing Broadcast Emergency Response), the device may display a vehicle license number in designated areas.

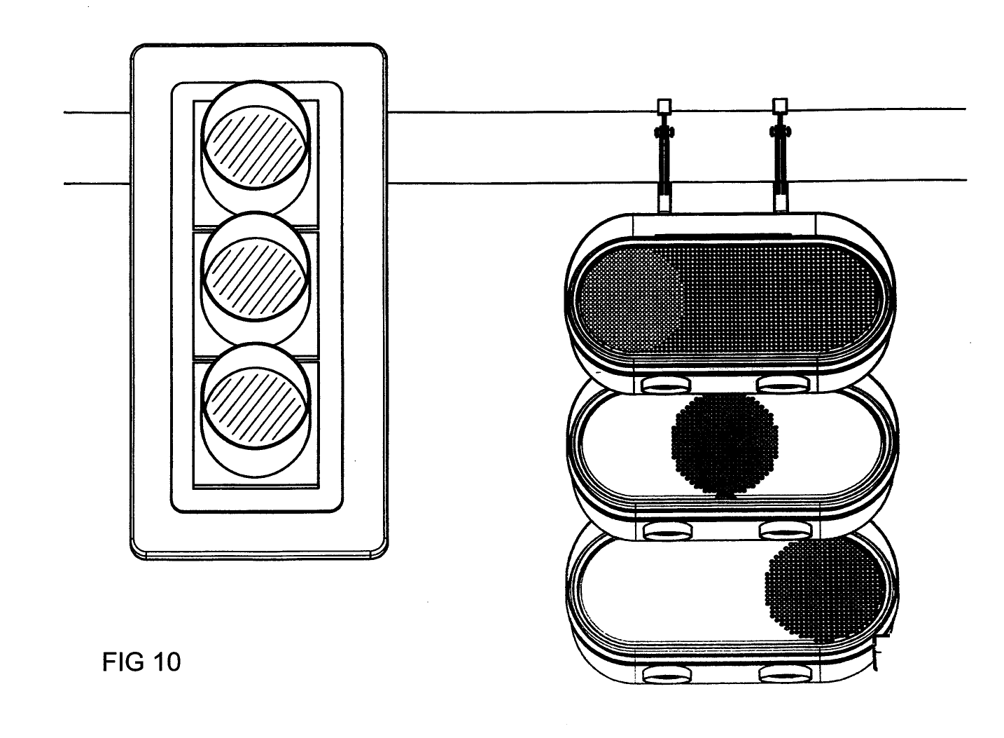

For increased signage visibility, the device may display street signs in the proper font and color for a particular municipality. Referring to FIG. 10, since the device comprises on board solar power, it may function as the primary traffic signal in the event of a power interruption to the conventional stop light. It is also contemplated that the system will interface with existing signaling devices currently employed on emergency vehicles, including infrared signaling devices, and particularly including the 3M OPTICON system.

While the present invention has been described with regards to particular embodiments, it is recognized that additional variations of the present invention may be devised without departing from the inventive concepts.

What is claimed is:

1. A modular traffic alert assembly comprising:
a. two or more approximately eighteen inch by twenty four inch rectangular panels, each with top, bottom and side edges and having a housing and an LED array contained therein capable of producing illuminated graphics;
b. a rail system supporting said two or more rectangular panels; and
c. wherein the two or more rectangular panels are aligned in a row and juxtaposed immediately adjacent, to display unitary images across said two or more panels, whereby a variety of signs can be displayed by the two or more panels.

2. The modular traffic alert signal of claim 1 wherein the two or more panels are aligned and juxtaposed along their eighteen inch sides, whereby a street name sign can be conveniently displayed.

3. The modular traffic alert signal of claim 1 wherein the two or more panels are aligned along their twenty four inch sides, whereby a regulatory sign can be conveniently displayed in a size and with dimensions according to municipal or other governmental codes.

4. The modular traffic alert signal of claim 1 wherein the rail system comprises a pair of spaced apart elongate members which are connected to the top and bottom edges of the two or more panels.

5. The modular traffic alert signal of claim 4 wherein the rail system comprises at least two brackets connecting said at least two panels to said rail system.

6. The modular traffic alert signal of claim 1 wherein the LED array comprises multiple LEDs capable of producing multicolored graphics including animated chevrons that start in green and proceed to red, directing drivers safely to the side of the road to let emergency vehicles pass, and animated emergency vehicles that show the direction of an approaching emergency vehicle.

7. The modular traffic alert signal of claim 1 wherein the housing comprises a transparent forward face and an aft face and a water-proof gasket therebetween to prevent moisture intrusion.

8. The modular traffic alert signal of claim 6 wherein the LED array displays moving animated images.

9. The modular traffic alert signal of claim 5 wherein the elongate members are hollow and configured to slidably accept the brackets.

10. The modular traffic alert signal of claim 1 further comprising vertical support members for adjusting the height of the at least two panels.

11. The modular traffic alert signal of claim 4 wherein the bottom rail is disposed in front of the at least two panels to act as a bumper for the LED array.

12. The modular traffic alert signal of claim 1 wherein the edges of said housing are beveled, whereby when the edge LEDs on the edge of two panels light up, a “V” shaped structure is created upon which the LED light refracts.

13. A modular traffic alert assembly comprising:
a. two or more approximately eighteen inch by twenty four inch rectangular panels, each with top, bottom and beveled side edges and each having a housing and an LED array contained therein capable of producing illuminated graphics;
b. a rail system supporting said two or more rectangular panels;
c. wherein two or more rectangular panels are aligned in a row and juxtaposed immediately adjacent each other, to display unitary images across said two or more panels, whereby a variety of signs can be displayed by the two or more panels; and
d. wherein the assembly is suspended in an off-set manner such that the assembly hangs about five degrees from vertical, whereby approaching traffic below is better able to view the LED array.

14. An improved traffic alert signal comprising:
a. a panel comprising a oval housing and a visor, said housing comprising an illuminated display apparatus, whereby the oval form represents a modified signal similar to a traditional traffic light form;
b. a multi-colored LED array capable of displaying moving animated images;
c. at least one bracket connected to said housing for suspending said housing; and
d. at least one speaker associated with said housing.

15. The modular traffic alert signal of claim 14 wherein the housing comprises a rear surface, and a solar array is disposed on said rear surface.

16. The modular traffic alert signal of claim 14 wherein the bracket comprises at least two connectors adapted for affixing to a signal pole.

17. The modular traffic alert signal of claim 16 wherein a cross brace connects the at least two connectors.

18. The modular traffic alert signal of claim 14 wherein the signal comprises a photo sensor for detecting the level of ambient light and automatically adjusting the brightness of said signal.
